(19) United States
(12) Patent Application Publication
(10) Pub. No.: US 2025/0310178 A1
(43) Pub. Date: Oct. 2, 2025

(54) Network Backbone Fault Management

(71) Applicant: DISH Wireless L.L.C., Englewood, CO (US)

(72) Inventors: Shawn Clark, Castle Rock, CO (US); Ryan Moos, Englewood, CO (US)

(73) Assignee: DISH Wireless L.L.C., Englewood, CO (US)

(21) Appl. No.: 19/065,923

(22) Filed: Feb. 27, 2025

Related U.S. Application Data
(60) Provisional application No. 63/569,868, filed on Mar. 26, 2024.

(51) Int. Cl. H04L 41/0631; H04L 41/0273; H04L 41/5009

(52) U.S. Cl. CPC H04L 41/0631; H04L 41/0273; H04L 41/5009

(57) ABSTRACT

A network backbone fault management system (NBFMS), for use with an Open Radio Access Network (ORAN) with a plurality of ORAN components includes a network operations center (NOC) storing computer instructions which instantiate one or more computer engines including a KAFKA® engine, a representational state transfer (REST) engine, a Query engine, a Rule engine, an Insights engine and an API engine. The NOC stores data in a cache and/or in a data lake coupled thereto. The KAFKA engine may monitor a data stream for event data published by an ORAN component. The Rules engine specifies types of event data to be monitored. The Rest engine determine whether relevance of environment data to an event, degradations of an ORAN component and elevations of a degradation. The Query engine retrieves data lake data. The Rule engine performs health checks for ORAN components.

### CROSS-REFERENCE TO RELATED APPLICATIONS

This application claims priority to and incorporates by reference, in its entirety, U.S. Provisional Patent Application Ser. No. 63/569,868, filed on 26 Mar. 2024, in the name of inventors Shawn Clark and Ryan Moos, and entitled “Network Backbone Fault Management.”

### TECHNICAL FIELD

The technology described herein generally relates to devices, systems, and processes for determining a real-time status of an Open Radio Access Network (“ORAN”) and addressing degradations to one or more components of a 5G ORAN on a substantially real-time basis.

### BACKGROUND

An ORAN may include thousands of network components, each generating data regarding one or more operating status, capabilities, configurations, degradations, and the like. The numerous network components often provide the generated data to one or more data stores, such as a centralized data repository.

A network operations center (“NOC”) monitors the status of the ORAN components. A NOC is commonly staffed by one or more operators. Herein, an “operator” is defined as one or more humans and/or Artificial Intelligence (“AI”) processes which monitor the ORAN, via the NOC. A NOC operator commonly should be able to determine a status of a given network component on a substantially real-time basis. Presently, systems for determining such status are lacking.

Further, when an outage in the ORAN occurs, it is commonly caused by one or more network components. To determine which network components are a cause of a degradation, contribute to an ORAN degradation, are impacted by a degradation, or otherwise (herein, an “impacted ORAN component”), NOC operators commonly have to seek and find data regarding the network components from the one or more data stores, identify data relevant to the outage, and act upon such data to alleviate the degradation. The seeking and finding of such data is time and labor intensive and often delays a resolution of a given degradation. When multiple network components are contributing to the degradation and/or when multiple outages are degradations occur, identifying data relevant to a given degradation is often time and effort intensive.

As used herein, a “degradation” refers to a reduction, in whole and/or in part, from one or more Quality of Service (“QoS”) level to be provided by the ORAN, and/or one or more ORAN components (as defined herein) to one or more end users, such as one or more end user mobile device. A degraded QoS may include any decrease in a current QoS, as determined in view of a given time or period, from an expected QoS. The expected QoS may be specified in one or more contract documents executed between a user and an ORAN operator.

Accordingly, devices, systems and methods for identifying, by NOC operators, current status of one or more ORAN components, degradations to the ORAN and/or ORAN components, ORAN components impacted by a degradation, and implementing a resolution to the degradation are needed.

### SUMMARY

Various implementations are described of devices, systems, and processes for determining a current status of one or more ORAN components, degradations to the ORAN and/or one or more ORAN components, identifying user devices, other devices, and/or other ORAN components that impacted by a given degradation, and resolving the given degradation.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more non-transitory computer programs can be configured to perform particular operations or actions by virtue of including instructions that, when executed by a data processing apparatus, cause the apparatus to perform the actions.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of an implementation of a network backbone fault management system and in accordance with at least one implementation of the present disclosure.

FIG. 2 is a schematic illustration of a network operations center (NOC) configured for use in the network backbone fault management system of FIG. 1 and in accordance with at least one implementation of the present disclosure.

### DETAILED DESCRIPTION

Various implementations of the present disclosure describe devices, systems, and processes for monitoring an operational status of multiple ORAN components, determining when a degradation has occurred to one or more ORAN components, and alleviating the degradation. For at least one implementation, the ORAN may be a fifth generation (“5G”) ORAN. For other implementations, the ORAN may be configured to support any generation of wireless networks.

“Acceptable delay” is a delay of less than a given metric, for example and not by limitation, four seconds (4 s) under normal system load conditions and thirty seconds (30 s) under heavy system load conditions. An acceptable delay may vary based on current system load conditions.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“AI/ML” (Artificial Intelligence/Machine Learning) herein refers to the use of one or more supervised learning, unsupervised learning, and/or refinement learning processes (as executed by one or more processors which may include processors associated with one or more neural networks) to determine one or more of the following: identifying user content relationship based upon user activities vis-à-vis multiple instances of content; identifying based on the user content relationships identified, one or more user preferences (likes, dislikes and neutral) with respect to content and/or content characteristics (as described below); searching, based on the identified user preference(s), content sources, content databases, content libraries, and portions of such content for one or more content portions to present to the given user (such content may include content previously presented and content not previously presented to the given user) in a condensed content data set; and providing to a user device, for presentation to a given user, the condensed content data set. For at least one implementation, AI/ML also refers to the use of refinement learning where user feedback is received in response to prior instances of content identified for presentation to the user and analyzed to further refine a model that associates user content preferences with user content activities.

“Application” (“App.”) herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Bus” herein refers to any known and/or later arising technologies which facilitate the transfer of data within and/or between components of a device. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating AET functions. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazom.com Inc., AZURE provided by Microsoft Corp., and others.

“Component” herein refers to a Module of a Device, as further defined herein.

“Computer Data” herein refers to Data, as further defined herein.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Computer instruction” herein refers to an Instruction, as further defined herein.

“Communications Interface” herein refers to one or more separately provided components and/or integrated with other components of a Device that is configured to facilitate communication of data with one or more other devices using a Coupling. Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in an ETS.

“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient and/or non-transient form, as determined by any given state of such data, at any given time. For a non-limiting example, a given data packet may be non-transient while stored in a storage device, but transient during communication of the given data packet from a first device or system to a second (or more) device or system. When received and stored in one or more of a cache, a memory, a data storage device, or otherwise, the given data packet has a non-transient state. For example, and not by limitation, data may take any form including as one or more applications, content, or otherwise. Instructions, as further described herein, are a form of data.

“Data store” herein refers to any non-transient device, combinations of devices, component of a device, combinations of components of one or more devices, or the like configured to store data on a temporary, permanent, non-transient, or other basis. A data store is also referred to herein as a “computer readable medium” and/or a “non-transitory computer readable medium.” A data store may store data in any form, such as electrically, magnetically, physically, optically, or otherwise. A data store may include a cache on a processor, memory devices, with non-limiting examples including random access memory (RAM) and read only memory (ROM) devices, and the like. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising data storage device technologies may be utilized for a given data store. Available storage provided by a given one or more data stores may be partitioned or otherwise designated by a storage controller as providing for permanent storage and temporary storage. Non-transient data, computer instructions, or other the like may be suitably stored in a data store permanently or temporarily. As used herein, permanent storage is distinguished from temporary storage, with the latter providing a location for temporarily storing data, variables, or other instructions used for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store data which, while communicated may be transient or non-transient, but while stored, is defined herein to be a form of non-transient data.

“Device” and “electronic device” herein refer to any known or later arising electrical device configured to, singularly and/or in combination, communicate, manipulate, output (e.g., for presentation as information to a human), process, store, or otherwise utilize data. One non-limiting example of a device includes a User Devices.

“Instruction” herein refers to a non-transient processor executable instruction, associated data structures, sequence of operations, program modules, or the like. An instruction is described by an instruction set. It is commonly appreciated that instruction sets are often processor specific and accordingly an instruction may be executed by a processor in a language format (e.g., a machine language format) that is translated from a higher level programming language (e.g., C++). An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient and/or non-transient basis, as may arise for any given data, content and/or instruction.

“Likely” as used herein means that a result has a greater than fifty percent (50%) probability of occurring.

“Module” (also referred to herein as a “Monitor”) herein refers to and, when claimed, recites definite structure for a device that is configured to provide at least one feature and/or output signals and/or perform at least one function including one or more of the features, output signals and functions described herein. A module/monitor may provide the one or more functions using computer engines, processors, computer instructions, and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module/monitor. Likewise, a POSITA will appreciate that such computer instructions may be provided in firmware, as embedded software, provided in a remote and/or local data store, accessed from other sources on an as-needed basis, or otherwise. Any known or later arising technologies may be used to provide a given module/monitor and the features and functions supported therein.

“Power Supply/Power” herein refers to any known or later arising technologies which facilitate the providing to and/or use by a device of electrical power. Non-limiting examples of such technologies include batteries, power converters, inductive charging components, line-power components, solar power components, and otherwise.

“Processor” herein refers to one or more known and/or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

“Security Component/Security” herein refers to any known or later arising components, processors, computer instructions, modules, and/or combinations thereof configured to secure data as communicated, processed, stored, output for presentation to a user, or otherwise manipulated. Non-limiting examples of security components include those which implement encryption/decryption standards, such as an Advanced Encryption Standard (AET), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include database servers, file servers, application servers, web servers, communications servers, virtual servers, computing servers, and the like. Servers may be combined into clusters (e.g., a server farm), logically or geographically grouped, or otherwise. Any known or later arising technologies may be used for a server.

A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Substantially simultaneous(ly)” herein refers to an absence of a greater than expected and humanly perceptible delay between a first event or condition and a second event or condition. Substantial simultaneity may vary in a range of quickest to slowest expected delay, to a moderate delay, or to a longer delay. For at least one implementation, substantial simultaneity occurs within an acceptable delay (as described above).

“User” herein refers to one or more of a single person, a household of people (such as those in a family), a collection of people (e.g., those in a fraternal organization or a club), or any other association of one or more human beings. A given household may have multiple users and/or collections of users (e.g., parents being one collection of users with children being a second collection of users in a household).

“User Device” herein refers to a device configured for use by a user to communicate, generate, compute, present, process, store, or otherwise manipulate data and/or information. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user and convert information to data and vice versa. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Network Backbone Fault Management System 100

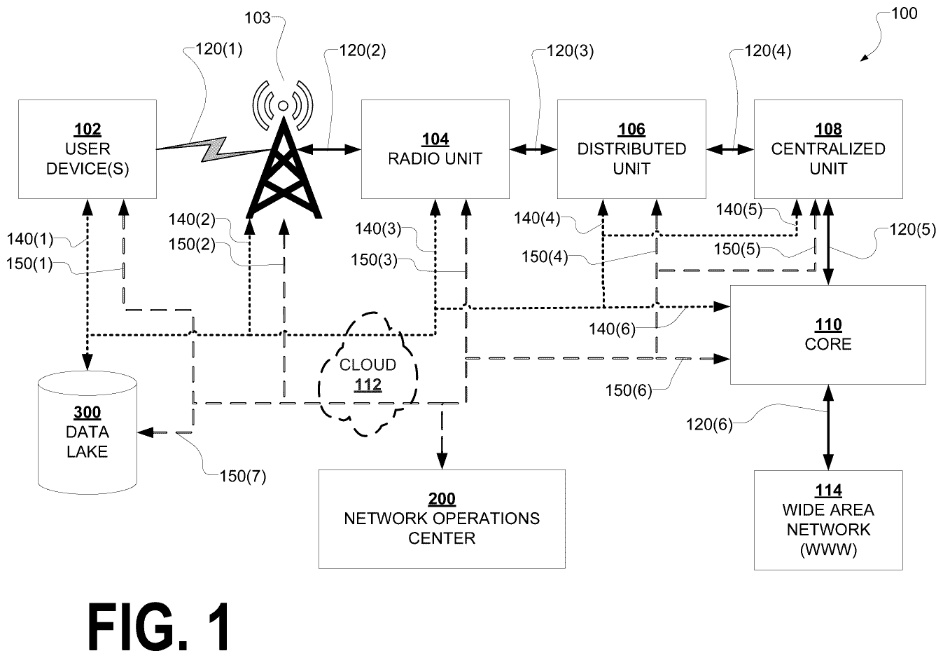

As shown in FIG. 1 and for at least one implementation of the present disclosure, a Network Backbone Fault Management System (“NBFMS”) 100 may include a NOC 200. The NOC 200 may be configured to monitor the status of, determine degradations of, alleviate degradations for an ORAN and one or more ORAN components utilized therein. For at least one implementation, the ORAN may include multiple ORAN components that may further include various ORAN sub-components. For purposes of simplicity of this description, such ORAN components and ORAN sub-components are referred to herein, individually and collectively, as an “ORAN component.” The ORAN components utilized in a given ORAN may include any known or later arising components that are configured and/or configurable for use in an ORAN implementation. It is to be appreciated that the type, quantity, characteristics, and otherwise of the given ORAN components utilized in a given ORAN implementation may vary from those ORAN components utilized in another ORAN implementation.

Non-limiting examples of ORAN components include radio towers 103, radio units 104, distributed units 106, centralized units 108, and cores 110. The ORAN components are coupled directly, indirectly or otherwise to a data lake 300. Such coupling may include, but is not limited to, use of the Cloud 112, local area networks, wide area networks (“WAN”) 114 (such as the world wide web (“WWW”), or other communicative couplings. The NOC 200 is also coupled to the data lake 300. Users of the ORAN may obtain operative use thereof via a user device 102 coupled to an ORAN component, for example, a user mobile device wirelessly coupled to a radio tower 103.

For at least one implementation, an ORAN component may be configured as a KAFKA® client. As is commonly known, KAFKA is an open-source system developed by the Apache Software Foundation, located in the State of Delaware, USA. A KAFKA client publishes data about a given device, system, or otherwise as a stream of “KAFKA events” to a KAFKA data broker. A KAFKA event commonly includes a key (e.g., an indicator of a type of event, component, or the like), a value (e.g., a result of an event), a timestamp (e.g., when the event was generated), and other metadata. For example, an event for an amplifier in a radio tower may indicate that the tower's amplifier (the key), is offline (the value), at a certain time (the timestamp).

For at least one implementation, an ORAN component may publish, e.g., in a KAFKA event stream, “component data” to a KAFKA data broker for storage thereby. As used herein, “component data” refers to data regarding a status, features, functions, capabilities, degradations, or otherwise of one or more ORAN components. When publishing data to a KAFKA broker or other storage element, the ORAN component may be configured and considered by a PHOSITA as a KAFKA producer.

For at least one implementation, one or more KAFKA data brokers provide a storage layer for the published events—the “component data.” For at least one implementation, the KAFKA data broker may include one or more data stores, as represented in FIG. 1 as the data lake 300.

For at least one implementation, component data may be organized and stored by the data lake 300, in various topics. For purposes of the present implementation, such topics may include one or more degradations to the ORAN and/or one or more ORAN components. Topics may further include data indicative of alleviations to a degradation, and other classifications and/or organizations of data.

As further shown in FIG. 1, the user devices 102 and ORAN components may be communicatively interconnected to facilitate the communication of “operative data” between a sending node and one or more receiving nodes using one or more “operative couplings” provided by the ORAN.

As used herein, “operative data” is data communicated between two or more ORAN nodes where the data is unrelated to the monitoring, control, operation, or otherwise of the ORAN, the ORAN node, and/or one or more ORAN components. Non-limiting examples of operative data include voice data, text message, emails, streaming audio and video, video data, audio data, graphical data, and other forms of data. For at least one implementation, operative data originates from a user device 102 and is received by another user device 102. As used herein, an “operative coupling” is a coupling that is used to facilitate the communication of “operative data” using an ORAN. An operative coupling may utilize one more physical, virtual and/or otherwise elements of an ORAN, as provided at a transport layer or other operational layer of the ORAN.

As shown in FIG. 1, the operative couplings are indicated, for purpose of illustration, by the solid lines. Non-limiting examples of operative couplings include: a first operative coupling 120(1) between a given user device 102 and a given radio tower 103; a second operative coupling 120(2) between the given radio tower 103 and a given radio unit 104; a third operative coupling 120(3) between the given radio unit 104 and a given distributed unit 106; a fourth operative coupling 120(4) between the given distributed unit 106 and a given centralized unit 108; a fifth operative coupling 120(5) between the given centralized unit 108 and a given core 110; and a sixth operative coupling 120(6) between the given core 110 and the WAN 114.

As discussed above, the ORAN components may publish component data in one or more event streams to the data lake 300. Such publication may occur using one or more “storage couplings” 140. As used herein, a “storage coupling” 140 is a coupling by which an ORAN component periodically, continually, on an as needed basis, upon request, or otherwise transmits component data to the data lake 300 in one or more KAFKA event streams. For at least one implementation, a storage coupling may utilize one more of the same or different physical, virtual and/or otherwise elements of the ORAN, as provided at a transport or other operational layer of the ORAN, and utilized by an operative coupling. As shown in FIG. 1, storage couplings are indicated, for purpose of illustration, by the thin dotted lines. Non-limiting examples of storage couplings include: a first storage coupling 140(1) between the given user device 102 and the data lake 300; a second storage coupling 140(2) between the given radio tower 103 and the data lake 300; a third storage coupling 140(3) between the given radio unit 104 and the data lake 300; a fourth storage coupling 140(4) between the given distributed unit 106 and the data lake 300; a fifth storage coupling 140(5) between the given centralized unit 108 and the data lake 300; and a sixth storage coupling 140(6) between the given core 110 and the data lake 300.

For at least one implementation, one more, including each, of the ORAN components may be coupled to the NOC 200 via one or more control couplings 140. As used herein, a “control coupling” is a coupling by which the NOC 200, functioning as a KAFKA client, obtains component data, for a given ORAN component, from the data lake 300. The component data may be used by the NOC 200 to perform NOC operations including, but not limited to, monitoring network components, controlling one more features and functions of a given ORAN component, determining degradations and/or impacts therefrom to the ORAN and/or one or more ORAN components, alleviating the degradations, preventing degradations, and otherwise. For at least one implementation, the control couplings 140 may be provided using, in whole or in part, one or more separate couplings, one or more of the operative couplings 120, and/or one or more of the storage couplings 140. As shown in FIG. 1, the control couplings are indicated, for purpose of illustration, by the thick dashed lines. Non-limiting examples of control couplings include: a first control coupling 150(1) between the given user device 102 and the NOC 200; a second control coupling 150(2) between the given radio tower 103 and the NOC 200; a third control coupling 150(3) between the given radio unit 104 and the NOC 200; a fourth control coupling 150(4) between the given distributed unit 106 and the NOC 200; a fifth control coupling 150(5) between the given centralized unit 108 and the NOC 200; a sixth control coupling 150(6) between the given core 110 and the NOC 200; and a seventh control coupling 150(7) between the data lake 300 and the NOC 200.

It is to be appreciated that an ORAN implemented on a regional, national or other basis, may include thousands of ORAN components that are coupled to each other by one or more operative couplings 120. Data regarding the operating status, degradations, and the like for one or more, including each, of the ORAN components may be communicated in KAFKA event streams to the data lake 300, using one or more storage couplings 140—such communications may occur on any basis, periodicity, or otherwise including, but not limited to, continually, on-demand, on a scheduled basis, intermittently, on request, upon detection of a degradation or impact thereof by/on a given ORAN component, or otherwise. It is to be appreciated that the data lake 300 may contain trillions of instances of component data (e.g., KAFKA events) that, at any given time, may organized into one or more files, folders, or other storage system configurations (e.g., as a KAFKA topic) relevant to the management of the ORAN, detection of a degradation, and alleviation of a given degradation. Such component data may be obtained from the data lake 300 by the NOC 200 using one or more control couplings 150.

### NOC Processor 202

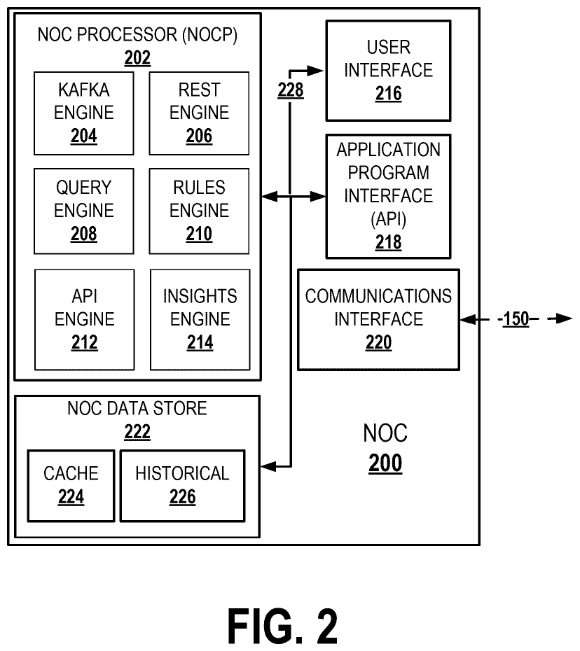

As shown in FIG. 2 and for at least one implementation of the present disclosure, the NOC 200 includes a NOC processor 202. The NOC processor 202 may be configured to execute computer instructions which facilitate NOC operations. The NOC 200 may be configured to interoperate with other known and/or later arising devices and systems configured to monitor one or more ORAN components, detect degradations thereto and degradations to the ORAN itself, and/or alleviate such degradations. It is to be appreciated that an alleviation of a given degradation to an ORAN and/or one or more ORAN components will commonly depend upon a given type of ORAN component, the degradation to the ORAN component, impacts to other ORAN components arising from the given degradation, resources available at a given time to alleviate the given degradation and/or impacts thereof, and other factors. Such alleviations may include re-routing of ORAN data to/by/through non-impacted ORAN components, replacing degraded and/or otherwise impacted ORAN components, discontinuing a service offering of the ORAN component, multiple ORAN components, of the ORAN itself, and/or performing other operations to alleviate, in whole or in part, the degradation. It is further to be appreciated that the NOC 200 may be configured to compartmentalize and/or conceptualize the ORAN at any level of physical, logical, virtual or other abstraction. Such compartmentalization and/or conceptualization may vary over time, intended use of the ORAN, or otherwise and may include one or more ORAN components.

For at least one implementation, the NOC operations may include, but are not limited to, the monitoring of ORAN components, detection of degradations to the ORAN and/or ORAN components, determining impacts of degradations on the ORAN (as conceptualized in whole or in part) and/or one or more ORAN components, alleviating a given degradation and/or impacts thereof on the ORAN and/or one or more ORAN components, and other operations which facilitate a substantially continually operational ORAN. As used herein a substantially continually operational ORAN is one which is operations three-hundred and sixty-five (365) days a year and for twenty-four (24) hours of each day, excluding any pre-planned down-times of the ORAN (in whole or in part) due to scheduled maintenance or other activities.

For at least one implementation, the NOC processor 202 may facilitate the NOC operations by instantiating one or more computer engines. Non-limiting examples of such computer engines include a KAFKA engine 204, a REST Engine 206, a Query engine 208, a Rules engine 210, an Application Program Interface (“API”) engine 212, and an Insights engine 214. These engines are further described herein.

### KAFKA Engine 204

For at least one implementation, the NOC processor 202 may be configured to execute computer instructions (herein for purposes of simplicity, “first computer instructions”) which facilitate a KAFKA engine 204 that performs KAFKA operations.

For at least one implementation, the KAFKA engine 204 is configured as one or more KAFKA “consumers.” For at least one implementation, the KAFKA engine 204 may receive and monitor one or more streams of event data on a substantially real-time basis. The streams may include event data which is associated with one or more KAFKA topics that the Rules engine 210 has instructed the KAFKA engine 204 to monitor. The KAFKA engine may be configured to monitor one or more event streams on any given basis, such as real-time, upon request, on a scheduled basis, upon receiving a prompt, or otherwise. Multiple KAFKA consumers may be instantiated by the KAFKA engine 204 to monitor event streams, topics, and the like, at any given time. The monitoring of event streams may occur at any given level of granularity, as requested by the Rules engine 210, such as on an ORAN component basis, on a sub-component basis, across multiple ORAN components, based on one more topics, combinations of topics, or otherwise. For at least one implementation, the KAFKA engine 204 is configured to monitor, on a substantially real-time basis, event streams provided by one or more ORAN components for degradations to the ORAN and/or one or more ORAN components.

For at least one implementation, upon detecting in one or more event streams a degradation and/or an impact of a degradation to the ORAN and/or an ORAN component, the KAFKA engine may output “impact data” to a cache 224 provided by the NOC data store 222; wherein the “impact data” identifies one or more of an event and an impact of the event.

### REST Engine 206

For at least one implementation, the NOC processor 202 may be configured to execute computer instructions (herein for purposes of simplicity, “second computer instructions”) which facilitate a Representational State Transfer (“REST”) engine 206 that performs REST operations. For at least one implementation, the REST engine 206 may be configured as a REST Application Program Interface (“API”) which functions as ingestion engine for data from various web servers or other data sources that do not form a part of the ORAN and/or are not an ORAN component. For at least one implementation, the REST engine 206 is configured to receive data from third party sources, such as the National Weather Services, the United States' National Oceanic and Atmospheric Administration (NOAA), local weather sources, emergency alert data sources and the like. Data provided by such third party sources are referred to herein as “environment data.” As used herein, environment data may include any data from any third party source that is relevant to a degradation and/or alleviation of a degradation-herein, “relevant” is used in accordance with its ordinary meaning to mean that a given data has a bearing on or a connection to a given degradation and/or an alleviation thereof. The environment data may be communicated to the REST engine 206 in any known or later arising data exchange format with non-limiting examples thereof including JSON (JavaScript Object Notation), HTML (hypertext markup language), XLT (extensible markup language), Python, PHP (hypertext processor), plain text, and the like.

For a non-limiting example of environment data, a degradation to the ORAN and/or an ORAN component may arise due to a weather event (e.g., a solar storm emitting high levels of electromagnetic energy which impact one or more 5G signals). The REST engine 206 may be configured to request and receive from a web server provided by the United States' National Oceanic and Atmospheric Administration, environment data regarding the solar storm. Such environment data may provide data relevant to a given degradation, a potential degradation, an extent in time, area or otherwise of an actual and/or potential degradation, and other data relevant to a minimization and/or alleviation of one or more degradations that have occurred or may occur in view of the given environment data (e.g., a given solar storm).

For at least one implementation, the REST engine 206 may communicate environment data to the cache 224.

For at least one implementation, the REST engine 206 may be configured to receive data from second “second party source” providing “source data.” As used herein, a “second party source” is a devices and/or system that provides data regarding an ORAN component and/or a service provided and/or monitored, in whole or in part, by an ORAN component that is managed, owned, monitored, operated, or otherwise provided or maintained by a device and/or system that is other an operator of the ORAN and/or an operator of the NOC 200. An example of a second party source may be SERVICENOW, and source data may include an incident ticket related to a degradation, a service change request, or the like for an ORAN component monitored by the second party source and is not actively monitored by the NOC 200, wherein “active monitoring”, as used herein, refers to monitoring of a status of a given ORAN component, by the NOC 200, on a substantially continually operational basis.

### QUERY Engine 208

For at least one implementation, the NOC processor 202 may be configured to execute computer instructions (herein for purposes of simplicity, “third computer instructions”) which facilitate a Query engine 208 that performs Query operations. For at least one implementation, the Query engine 208 may be configured as an ingestion engine for data stored in the data lake 300 (herein, such data being “data lake data” or “DLD”). As discussed above, the DLD may correspond to one or more event streams generated by one or more ORAN components. For at least one implementation, the Query engine 208 may be configured to obtain the DLD from the data lake 300, where the DLD is distinct from other data being provided to the Rules engine by the KAFKA engine 204 and/or the REST engine 206. For at least one implementation, the Query engine 208 may request the DLD from the data lake 300, or other data sources. For at least one implementation, the Query engine 208 populates the DLD into the cache 224.

For at least one implementation, the DLD may include network topology data. Network topology data may include data regarding a topology of the ORAN at any given time, data regarding one or more transport layers for the ORAN, data regarding the Core 110 for the ORAN, and the like. For at least one implementation, the DLD may include various performance metrics, fault metrics, and the like for the network. Performance metrics may be generated and/or provided by one or more cloud-native software applications and/or other software and/or hardware applications and/or systems, and/or providers thereof, with non-limiting examples including MAVENIR™, which is provided by Mavenir Systems, Inc. located in Richardson, Texas, USA, Samsung, Inc., CISCO Systems, Inc., SITEBOSS™ manufactured by Asentria Inc., located in Seattle, Washington, USA. Non-limiting examples of such performance metrics and/or fault metrics may include utilization percentages for processor units, memory and/or data storage units, transport link status data, simple network management protocol (SNMP) “traps”, and the like. Herein a “high” utilization of a given system components is a utilization that is ninety-percent (90%) or higher of the then available system components (e.g., network processors, links, or the like). For at least one implementation, the performance metrics and/or fault metrics may be populated into and, when obtained from the data lake 300, provided to the cache 224 as DLD.

For at least one implementation, the Query engine 206 may be configured to request DLD from the data lake 300 and/or other data sources based on a given degradation and/or a status thereof, a selection of a given ORAN component by a NOC operator, a detection of an alert condition for the ORAN, or otherwise. The Query engine 206 may be configured to output the DLD retrieved from the data lake 300 or other data sources to the cache 224.

For at least one implementation, the Query engine 206 may be instructed by the Rules engine 210 to obtain DLD from the data lake 300 component data and/or environment data which may be relevant to a given degradation. Such request may occur when a degradation is initially detected, as may occur by an alert message or the like is first generated by an ORAN component, or at a later time. The DLD retrieved may include component data and/or environment data and may be used by the NOC 200 to more specifically identify one or more ORAN components and/or one or more environmental factors, directly and/or indirectly, that are causing or have caused the degradation, one or more ORAN components impacted by the degradation, and one or more alleviations of the degradation. For example, the Query engine 206 may request DLD for ORAN components that are not causing or impacted by a given current degradation. Such DLD may be provided by the Query engine 208 to the Rules engine 210 for further processing.

For at least one implementation, the Query engine 206 may be further configured to perform one or more update requests for additional DLD that includes updates to component data and/or environmental data while a degradation is on-going. Such update requests may be performed on any given basis including, but not limited to, on-demand, on a periodic basis (e.g., once every five (5) minutes), based upon a change in an ORAN component (e.g., an improvement or further degradation in an operational or other characteristic of a previously degraded and/or newly degraded ORAN component), an auxiliary data (e.g., an update provided by a NOAA server indicating that a given solar storm has increased or decreased in intensity), or the like.

### Rules Engine 210

For at least one implementation, the NOC processor 202 may be configured to execute computer instructions (herein for purposes of simplicity, “fourth computer instructions”) which facilitate a Rules engine 210 that performs rules operations. The Rules engine 210 may be configured to monitor the cache 224 for data provided thereto by the KAFKA engine 204, the REST engine 206 and the Query engine 208. For at least one implementation, the Rules engine 210 performs one or more health checks of one or more ORAN components and/or the ORAN. Such health checks may be performed on any given basis, with respect to one more ORAN components. One or more business logic rules implemented by the Rules engine 210 dictate when a given health check is performed with respect to a given ORAN component. It is to be appreciated that health checks for a given ORAN component may occur on any basis including on a schedule, on-demand, or otherwise. The occurrence of and/or frequency of a health check for a given ORAN component may vary based on an importance of the given ORAN component and/or service provided by the ORAN, wherein the importance thereof may be indicated by an importance rating ranging from, for a non-limiting example, one to ten (1-10) with a rating of one (1) being indicative of a lowest importance and a rating of ten (1) being indicative of a highest importance.

For at least one implementation, the Rules engine 210 may be configured to execute one or more business logic rules. The business logic rules configure the Rule engine 210 to detect degradations and identify one or more causes and/or sources of a given degradation and/or a collection of degradations. For example, the Rules engine 210 may receive data from the Rest engine 206 that a given component, e.g., a radio tower 103, is experiencing a degradation. In response, the Rules engine 210 may perform one or more health checks of the given radio tower 103. Such health checks may include the Rules engine 210 instructing the KAFKA engine 204 to monitor event streams for the given radio tower 103 and loading data in such event streams into the cache 224. The Rule engine 210 may also request the Query engine 208 to search for and retrieve data from the data lake 300, and load into the cache 224, regarding the given radio tower 103 and/or ORAN components coupled thereto. Such search and retrieval may be for data regarding any given current period and/or past periods. The Rules engine 210 may also request the REST engine 206 to search for and retrieve environment data and/or source data and to load such data into the cache 224. The Rules engine 210 may retrieve such data from the cache 224 for further analysis. When multiple ORAN components are experiencing a degradation, data for each of such multiple ORAN components may be loaded into the cache 224 and retrieved for analysis thereof by the Rules engine 210.

Further, the Rules engine 210 may be configured to utilize data for one or more, including multiple, degradations occurring across multiple ORAN components to perform root cause investigations and analysis and thereby identify an underlying cause of a given one or more, including multiple, ORAN component degradation(s). For example, when multiple radio towers 103 within a given geographic area are experiencing a degradation, e.g., due to solar activity, the Rules engine 201 may be configured to perform health checks on each of the multiple radio towers, which indicate that the radio towers themselves are fully operational, request environment data retrieval by the REST engine 206, and based on the environment data determine that the degradations being experienced by the multiple radio towers is due to the solar activity. Based on such root cause analysis and determinations, the Rule engine 210 may be configured to output results data of such root cause analysis to the API engine 212.

### API Engine 212

For at least one implementation, the NOC processor 202 may be configured to execute computer instructions (herein for purposes of simplicity, “fifth computer instructions”) which facilitate an API engine 212 which performs API operations. The API engine 212 may be configured to receive data from the Rules engine 210 and convert such data for presentation to a NOC operator, via a NOC user interface 216, a current status of one or more of the ORAN components. For at least one implementation, the API engine 212 may be configured to integrate with one or more other ORAN management systems and/or tools, which are further configured to implement one or more operations which address and/or alleviate degradations, in whole or in part, to the ORAN and/or one or more ORAN components. A non-limiting example of a management system configured to address degradations to one or more ORAN components is the SERVICENOW® software as a service platform provided by ServiceNow, Inc. of Santa Clara, California, USA.

### Insights Engine 214

For at least one implementation, the NOC processor 202 may be configured to execute computer instructions (herein for purposes of simplicity, “sixth computer instructions”) which facilitate an Insights engine 214 which performs Insights operations. The Insights engine 214 may be configured to perform one or more AI/ML operations which using one or more correlation and/or anomaly processing routines determines one or more characteristics of past degradations that are indicative of a likely future degradation (i.e., one that is more than 50% likely to occur within a given period). Based on such correlation and analysis, the Insights Engine 214 may provide “historical data” to the API engine 212, wherein “historical data” is herein defined as data indicative of a likely degradation to one or more ORAN components and within a given period. The historical data may be converted by the API engine into a format suitable for presentation to a NOC operator and utilizes thereby to avoid and/or minimize an impact of a likely future degradation.

For at least one implementation, the Insights Engine 214 may utilize one or more AI/ML models to perform the correlation and analysis operations.

### NOC Data Store 222

As further shown in FIG. 2, the NOC 200 may include a NOC data store 222 that stores data in a cache 224 and in one or more historical 226 data structures. For at least one implementation, the cache 224 may include data received from one or more of the KAFKA engine 202, the REST engine 204, and/or the Query Engine 206. The cache 224 facilitates short-term storage of data relevant to a given current status of the ORAN, an ORAN component, a current degradation, and/or an alleviation of current degradation. The historical 226 data structure stores data that may be used by the Insights engine 214 to perform the correlation and analysis operations and thereby predict future degradations and/or identify approaches for alleviating current and/or future degradations and/or impacts thereof on the ORAN and/or one or more ORAN components. For at least one implementation, the historical 226 may include data regarding previous degradations (and alleviations thereof) of the ORAN (in whole or in part) and/or of one or more ORAN components.

### NOC User Interface 216

The NOC 200 may further include a user interface 216 configured to convert data received from the API engine 212 into information presentable to a NOC operator in a humanly perceptible format (when the operator is human) and/or AI perceptible format (when appropriate). The user interface 216 may be configured to convert data into a format that informs an operator of the status of the ORAN (in whole or in part) and/or an ORAN component.

For at least one implementation, a color coding scheme (or other form of alert scheme which may include visible, audible, textual, graphical or other forms of indicators) may be utilized to visually inform a NOC operator of a status of the ORAN, and/or an ORAN component. For at least one implementation, a visible alert scheme may include use of a red color to indicate, at a given level of abstraction of the ORAN and/or one or more ORAN components, a degradation of the ORAN portion (which may include the ORAN in whole or in part) and/or the ORAN components. A yellow color may indicate an impacted ORAN portion and/or ORAN component. For at least one implementation, the degradation and/or impact may be determined by the NOC processor 202 based on a comparison of a current QoS in view of an expected QoS. Such QoS determinations may be made in view of any level of abstraction, such as on a NOC global, regional, local, and/or user level. A green color may indicate an ORAN portion and/or ORAN component that is operating, at a given time, in accordance with one or more performance benchmarks, such as an expected QoS.

For at least one implementation, the NOC 200 may be configured to support a drilling down of ORAN and ORAN component status information (including degradations and impacts) to any given level of abstraction of the ORAN, an ORAN component and/or on a sub-component and/or lower level basis for one or more given ORAN components. For example, data stored in the data lake 300 for a given tower component may include tower data 304. Such tower data 304 may include data regarding sub-components thereof, such as antenna, amplifiers, filters, power systems, or the like. Such tower data 304 may further include data indicative of a current status, setting, configuration, operational state or otherwise (herein, “status data”) of the NOC component, one or more sub-components thereof and/or one or more elements, parts, or the like (herein “an element”) of a sub-component. The tower data 304 may include any data generated by a NOC component or division thereof. For example, a radio tower 103 may include an amplifier, which further includes an input/output port, a power port, and the like. Status data for the NOC component (the radio tower), the sub-component (the amplifier), and the element (the input/output port) may be generated (by the amplifier) and communicated to the data lake 300 for storage thereby. The NOC 200 may be configured to request such data from the data lake 300, determine a status of the NOC component (e.g., a status of a given radio tower 103), determine a status of a sub-component of the NOC component (e.g., a status of the radio tower's amplifier), determine a status of an element of the sub-component of the NOC component (e.g., a status of the input/output port of the radio tower's amplifier), and present such status information to the NOC operator vias the NOC's user interface 216.

The NOC 200 may further include a communications interface 220, a security component, a power supply, a bus 228, and other components commonly utilized in a NOC 200. Any known and/or later arising instances of an API interface, communications interface, security component, power supply, bus, or the like may be utilized in an implementation of the present disclosure.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A network backbone fault management system (NBFMS), for use with an Open Radio Access Network (ORAN) that includes a plurality of ORAN components, comprising:
a network operations center (NOC); and
wherein the NOC comprises:
a processor; and
a non-transitory NOC data store, coupled to the NOC processor, non-transitorily storing NOC computer instructions, which when executed by the processor, instantiate one or more computer engines, including:
a KAFKA® engine;
a representational state transfer (REST) engine;
a Query engine;
a Rule engine;
an Insights engine; and
an API engine; and
wherein the NOC data store stores data received from the one or more computer engines in a cache; and
a data lake, coupled to the NOC.

2. The NBFMS of claim 1,
wherein the plurality of ORAN components includes:
a plurality of user devices;
a plurality of radio towers;
a plurality of radio units;
at least one distributed unit;
at least one centralized unit; and
at least one ORAN core.

3. The NBFMS of claim 1,
wherein the NOC computer instructions include:
first computer instructions, which when executed by the NOC processor, instantiate the KAFKA® engine which performs KAFKA operations including:
monitoring a KAFKA data stream for event data, for a given event type, published by a given ORAN component of the plurality of ORAN components onto the storage coupling;
wherein the monitoring occurs in accordance with a request received from the Rules engine for monitoring of the given event type;
wherein the given ORAN component is configured as a KAFKA client;
wherein the event data includes:
a key indicative of at least a type of event and the given ORAN component;
a value indicative of an impact of the given event on at least one of the given ORAN component and the ORAN;
a timestamp indicative when the given event occurred; and
metadata pertinent to the given ORAN component and the given event; and
outputting, when the given event is detected on the KAFKA data stream, impact data to the cache;
wherein the impact data identifies, based on the event data, the given event and an impact of the given event on at least one of the given ORAN component and the ORAN.

4. The NBFMS of claim 1,
wherein the NOC computer instructions include:
second computer instructions, which when executed by the NOC processor, instantiate the REST engine which performs REST operations including:
monitoring at least one web server for environment data;
determining, when environment data is detected, whether the environment data may be relevant to the given event and at least one of:
a degradation of at least one of the given ORAN component and the ORAN; and
an alleviation of the given degradation; and
outputting the environment data to the cache, when the environment data is detected by the REST engine.

5. The NBFMS of claim 1,
wherein the NOC computer instructions include:
third computer instructions, which when executed by the NOC processor, instantiate the Query engine which performs Query operations including:
retrieving data lake data (DLD) from the data lake;
wherein the DLD includes:
network topology data, at a given time, for the ORAN;
retrieving at least one performance metric for at least one of the given ORAN component and the ORAN;
retrieving at least one faut metric for at least one of the given ORAN components and the ORAN; and
outputting the DLD to the cache.

6. The NBFMS of claim 5,
wherein the NOC computer instructions include:
fourth computer instructions, which when executed by the NOC processor, instantiate the Rules engine which performs Rules operations including:
monitoring the cache for impact data, environment data, and DLD;
performing, in accordance with at least one business logic rule and based on one or more of the impact data, environment data and DLD, a health check on at least one of the given ORAN component and the ORAN;
wherein the business logic rule is generated based one at least one of:
an artificial intelligence process;
a schedule; and
on-demand; and
wherein the business logic rule is implemented based on an importance rating of at least one of the given ORAN component and a service provided by the ORAN that is impacted by the given event;
performing root cause investigation and analysis for the given event; and
outputting results data, indicative of results obtained from the root cause investigation and analysis, to the API engine.

7. The NBFMS of claim 1,
wherein the NOC computer instructions include:
fifth computer instructions, which when executed by the NOC processor, instantiate the API engine which performs API operations including:
receiving the results data from the Rules engine;
converting the results data into a humanly perceptible form results data; and
outputting the humanly perceptible form results data to a presentation device for presentation to a NOC operator.

8. The NBFMS of claim 1,
wherein the NOC computer instructions include:
sixth computer instructions, which when executed by the NOC processor, instantiate the Insights engine which performs Insight operations including:
determining past characteristics of two or more past degradations;
predicting, based on the past characteristics, whether current characteristics are indicative of a likely degradation occurring within a given period; and
identifying, based on the past characteristics, actions available to at least one of avoid and reduce impacts of the likely degradation; and
generating, for presentation to a NOC operator, a result of the predicting and the actions available.

9. A computer readable medium non-transitorily storing Network Operations Center (NOC) computer instructions including:
first computer instructions which, when executed by a NOC processor coupled to the computer readable medium, instantiates a KAFKA® engine;
wherein the KAFKA engine configures the NOC to perform KAFKA operations comprising:
monitoring a KAFKA data stream for event data, for a given event type, published by a given Open Radio Access Network (ORAN) component of a plurality of ORAN components onto a storage coupling;
wherein the monitoring occurs in accordance with a request received from a Rules engine for monitoring of the given event type;
wherein the given ORAN component is configured as a KAFKA client;
wherein the event data includes:
a key indicative of at least a type of event and the given ORAN component;
a value indicative of an impact of the given event on at least one of the given ORAN component and the ORAN;
a timestamp indicative when the given event occurred; and
metadata pertinent to the given ORAN component and the given event; and
outputting, when the given event is detected on the KAFKA data stream, impact data to the cache;
wherein the impact data identifies, based on the event data, the given event and an impact of the given event on at least one of the given ORAN component and the ORAN.

10. The computer readable medium of claim 9,
wherein the plurality of ORAN components include at least one of:
a user device;
a radio tower;
a radio unit;
a distributed unit;
a centralized unit; and
an ORAN core.

11. The computer readable medium of claim 10,
wherein the NOC computer instructions include second computer instructions, which when executed by the NOC processor, instantiate a representational state transfer (REST) engine which configures the NOC to performs REST operations including:
monitoring at least one web server for environment data;
determining, when environment data is detected, whether the environment data may be relevant to a given event and at least one of:
a degradation of at least one of the given ORAN component and the ORAN; and
an alleviation of the given degradation; and
outputting the environment data to the cache, when the environment data is detected by the REST engine.

12. The computer readable medium of claim 11,
wherein the NOC computer instructions include third computer instructions, which when executed by the NOC processor, instantiate the Query engine which configure the NOC to perform Query operations including:
retrieving data lake data (DLD) from a data lake coupled to the NOC processor;
wherein the DLD includes network topology data, at a given time, for the ORAN;
retrieving at least one performance metric for at least one of the given ORAN component and the ORAN;
retrieving at least one faut metric for at least one of the given ORAN components and the ORAN; and
outputting the DLD to the cache.

13. The computer readable medium of claim 12,
wherein the NOC computer instructions include fourth computer instructions, which, when executed by the NOC processor, instantiate a Rules engine which configures the NOC to perform Rules operations including:
monitoring the cache for impact data, environment data, and DLD;
performing, in accordance with at least one business logic rule and based on one or more of the impact data, environment data and DLD, a health check on at least one of the given ORAN components and the ORAN;
wherein the business logic rule is generated based one at least one of:
an artificial intelligence process;
a schedule; and
on-demand; and
wherein the business logic rule is implemented based on an importance rating of at least one of the given ORAN component and a service provided by the ORAN that is impacted by the given event;
performing root cause investigation and analysis for the given event; and
outputting results data, indicative of results obtained from the root cause investigation and analysis, to the API engine.

14. The computer readable medium of claim 13,
wherein the NOC computer instructions include fifth computer instructions which, when executed by the NOC processor, instantiate an API engine which configures the NOC to perform API operations including:
receiving the results data from the Rules engine;
converting the results data into a humanly perceptible form results data; and
outputting the humanly perceptible form results data to a presentation device for presentation to a NOC operator.

15. The computer readable medium of claim 14,
wherein the NOC computer instructions include sixth computer instructions which, when executed by the NOC processor, instantiate the Insights engine which configures the NOC to perform Insight operations including:
determining past characteristics of two or more past degradations;
predicting, based on the past characteristics, whether current characteristics are indicative of a likely degradation occurring within a given period;
identifying, based on the past characteristics, actions available to at least one of avoid and reduce impacts of the likely degradation; and
generating, for presentation to a NOC operator, a result of the predicting and the actions available.

16. A method for managing faults on an Open Radio Access Network (ORAN) comprising:
instantiating a KAFKA® engine on a Network Operations Center (NOC) processor for the ORAN;
instantiating a representational state transfer (REST) engine on the NOC processor;
instantiating a query engine on the NOC processor;
instantiating a rules engine on the NOC processor;
instantiating an Applications Program Interface (API) engine on the NOC processor; and
instantiating an Insights engine on the NOC processor.

17. The method of claim 16,
wherein the KAFKA engine configures the NOC to perform KAFKA operations comprising:
monitoring a KAFKA data stream for event data, for a given event type, published by a given ORAN component of a plurality of ORAN components onto a storage coupling;
wherein the monitoring occurs in accordance with a request received from a Rules engine for monitoring of the given event type; and
outputting, when the given event is detected on the KAFKA data stream, impact data to the cache;
wherein the impact data identifies, based on the event data, the given event and an impact of the given event on at least one of the given ORAN component and the ORAN.

18. The method of claim 17,
wherein the given ORAN component is configured as a KAFKA client;
wherein the event data includes:
a key indicative of at least a type of event and the given ORAN component;
a value indicative of an impact of the given event on at least one of the given ORAN component and the ORAN;
a timestamp indicative when the given event occurred; and
metadata pertinent to the given ORAN component and the given event.

19. The method of claim 16,
wherein the REST engine configures the NOC to performs REST operations including:
monitoring at least one web server, coupled to the NOC processor, for environment data;
determining, when environment data is detected, whether the environment data may be relevant to a given event and at least one of:
a degradation of at least one of a given ORAN component and the ORAN; and
an alleviation of the given degradation; and
outputting the environment data to the cache, when the environment data is detected by the REST engine.

20. The method of claim 16,
wherein the Query engine configures the NOC to perform Query operations including:
retrieving data lake data (DLD) from a data lake coupled to the NOC processor;
wherein the DLD includes network topology data, at a given time, for the ORAN;
retrieving at least one performance metric for at least one of a given ORAN component and the ORAN;
retrieving at least one faut metric for at least one of the given ORAN components and the ORAN; and
outputting the DLD to the cache;
wherein the Rules engine configures the NOC to perform Rules operations including:
monitoring the cache for impact data, environment data, and DLD;
performing, in accordance with at least one business logic rule and based on one or more of the impact data, environment data and DLD, a health check on at least one of the given ORAN components and the ORAN;
wherein the business logic rule is implemented based on an importance rating of at least one of the given ORAN component and a service provided by the ORAN that is impacted by the given event;
performing root cause investigation and analysis for the given event; and
outputting results data, indicative of results obtained from the root cause investigation and analysis, to an API engine;
wherein the API engine configures the NOC to perform API operations including:
receiving the results data from the Rules engine;
converting the results data into a humanly perceptible form results data; and
outputting the humanly perceptible form results data to a presentation device for presentation to a NOC operator; and
wherein the Insights engine configures the NOC to perform Insight operations including:
determining past characteristics of two or more past degradations;
predicting, based on the past characteristics, whether current characteristics are indicative of a likely degradation occurring within a given period;
identifying, based on the past characteristics, actions available to at least one of avoid and reduce impacts of the likely degradation; and
generating, for presentation to a NOC operator, a result of the predicting and the actions available.
